(19) United States
(12) Patent Application Publication
(10) Pub. No.: US 2002/0000780 A1
(43) Pub. Date: Jan. 3, 2002

(54) Glow starter for a high pressure discharge lamp

(75) Inventors: Naoya Matsumoto, Kanagawa-ken (JP); Hiroyuki Ogata, Kanagawa-ken (JP); Satoshi Iwasawa, Kanagawa-ken (JP); Takahito Kashiwagi, Kanagawa-ken (JP); Akira Ito, Kanagawa-ken (JP); Daisuke Takayama, Kanagawa-ken (JP); Makoto Hashimoato, Kanagawa-ken (JP); Toshihiko Ishigami, Kanagawa-ken (JP)

Correspondence Address: Pillsbury Winthrop LLP, Intellectual Property Group, 1600 Tysons Boulevard, McLean, VA, 22102, US

(73) Assignee: TOSHIBA LIGHTING & TECHNOLOGY CORPORATION, Tokyo (JP)

(21) Appl. No.: 09/886,053

(22) Filed: Jun. 22, 2001

(30) Foreign Application Priority Data
Jun. 30, 2000 (JP) 2000-199993
Nov. 7, 2000 (JP) 2000-338780
Dec. 26, 2000 (JP) 2000-395470

(51) Int. Cl. H01J 11/04

(52) U.S. Cl. 315/344

(57) ABSTRACT

A glow starter comprises a discharge vessel, filled with a filling including a rare gas, substantially transmitting ultraviolet rays of about 300 nm or less. A pair of electrodes, which are arranged in the discharge vessel, is adapted and arranged to touch each ether by being heated by a glow discharge. The glow starter may be used for a high pressure discharge lamp, a high pressure discharge lamp apparatus, or a lighting fixture.

### BACKGROUND OF THE INVENTION

1. Field of the Invention

The present invention relates to a glow starter, which can be applied to a high pressure discharge lamp.

2. Description of the Related Art

High pressure discharge lamps, such as metal halide discharge lamps are increasingly utilized in lighting fixtures because of their high efficiency and color rendering property in comparison with mercury vapor lamps. The metal halide discharge lamp, however, does not start easily, because it is typically supplied with a low discharge starting voltage or a secondary voltage generated by a ballast, such as that which is usually applied to a mercury vapor lamp. The ballast for the mercury vapor lamp is generally utilized, because it is low in cost and compact. However, the starting voltage of the metal halide lamp tends to be high as a result of impurities, e.g., moisture (H₂O), which can easily be included with the metal halide and rare gas when the arc tube is filled. The impurities make it more difficult for a discharge to start. In order to improve the starting, the filling pressure of the rare gas can be decreased. However, when the pressure of the rare gas is reduced, the electron emissive material of the electrodes is vaporized excessively at the beginning of the discharge. As a result, the arc tube is blackened, and its luminous flux is reduced over the lamp's operation.

To solve this problem, when a ballast for a mercury vapor lamp is used in a metal halide lamp, the lamp includes a starter device including a glow starter connected in parallel to the arc tube. When current from the ballast initially passes through the grow starter, an arc discharge is created. As the arc discharge heats bimetallic elements in the grow starter, the bimetallic elements touch to directly pass current. This causes the arc discharge to be extinguished and the bimetallic elements cool. When the elements cool sufficiently, they separate, creating a counter-electromagnetic force in the ballast which produces a high starting voltage pulse for the metal halide lamp.

To improve starting, a metal halide lamp may comprise an initial electron generating material, e.g., promethium (¹⁴⁷Pm). However, it is difficult to handle and dispose of promethium (¹⁴⁷Pm) because it is a radioactive isotope.

Furthermore, Japanese Laid Open Patent Application HEI 1-134848 discloses a metal halide lamp which starts more easily. Such metal halide lamp comprises an ultraviolet ray generator arranged near the arc tube. The generator irradiates the arc tube with ultraviolet rays, so that the metal halide lamp tends to start more easily. The ultraviolet ray generator includes an ultraviolet ray- transmitting vessel made of a borosilicate glass or a silica glass, and a single electrode. Furthermore, the vessel of the generator is arranged near a lead wire which supplies electric current to an electrode of the arc tube. According to the application, ultraviolet rays are generated between the lead wire and the single electrode before the metal halide lamp starts. The metal halide lamp does not have a glow starter in the outer bulb, but has an igniter outside. This metal halide lamp has both the ultraviolet ray generator and the igniter to assist in starting the metal halide lamp.

Furthermore, Japanese Laid Open Utility Model Application SHO 63-3086 discloses generating ultraviolet rays using a glow starter. The glow starter includes a vessel made of a quartz glass or a silica glass filled with mercury (Hg), so that ultraviolet rays are generated by a mercury vapor discharge. The application further discloses that the glow starter vessel is made of soft glass and ultraviolet rays of 297 nm, 302 nm, and 313 nm are generated by the mercury vapor discharge. However, in order to generate ultraviolet rays of 297 nm, 302 nm, and 313 nm, a large amount of mercury may be required, which is not friendly to the environment.

### SUMMARY OF THE INVENTION

The According to one aspect of the invention, a glow starter comprises a discharge vessel, filled with a gas mix including a rare gas. The glow starter transmits ultraviolet rays substantially of about 300nm or less. A pair of electrodes, which are arranged in the discharge vessel, are adapted and arranged to touch each other as a result of being heated by a glow discharge.

According to another aspect of the invention, a high pressure discharge lamp comprises an arc tube, the glow starter, and an outer bulb accommodating the arc tube and the glow starter.

According to another aspect of the invention, a high pressure discharge lamp apparatus comprises a high pressure discharge lamp. A ballast, which has a rated input voltage of about 100V or about 200V, and supplies a secondary voltage between about 200V and about 220V to the high pressure discharge lamp, is arranged in series between an alternating current supply and the high pressure discharge lamp.

According to another aspect of the invention, a lighting fixture comprises a high pressure discharge lamp apparatus, and a body having a lamp socket and a reflector.

These and other aspects of the invention will be further described in the following drawings and detailed description of the invention.

### BRIEF DESCRIPTION OF THE DRAWINGS

The invention will be described in more detail below by way of examples illustrated by drawings in which:

FIG. 1 is an enlarged side view, partly in section, of a glow starter according to a first embodiment of the present invention;

FIG. 2 is a side view of a high pressure discharge lamp according to the present invention;

FIG. 3 is a circuit diagram of a high pressure discharge lamp apparatus according to the first embodiment of the present invention;

FIG. 4 is a graph showing a transmittance as a wavelength according to the present invention;

FIG. 5 is a side view of an assembly of a metal halide lamp according to a second embodiment of the present invention;

FIG. 6 is another side view of the assembly of the metal halide lamp shown in FIG. 5;

FIG. 7 is a circuit diagram of a high pressure discharge lamp apparatus according to the second embodiment of the present invention; and

FIG. 8 is a side view, partly in section, of a lighting fixture according to the present invention.

### DETAILED DESCRIPTION OF SEVERAL EMBODIMENTS OF THE INVENTION

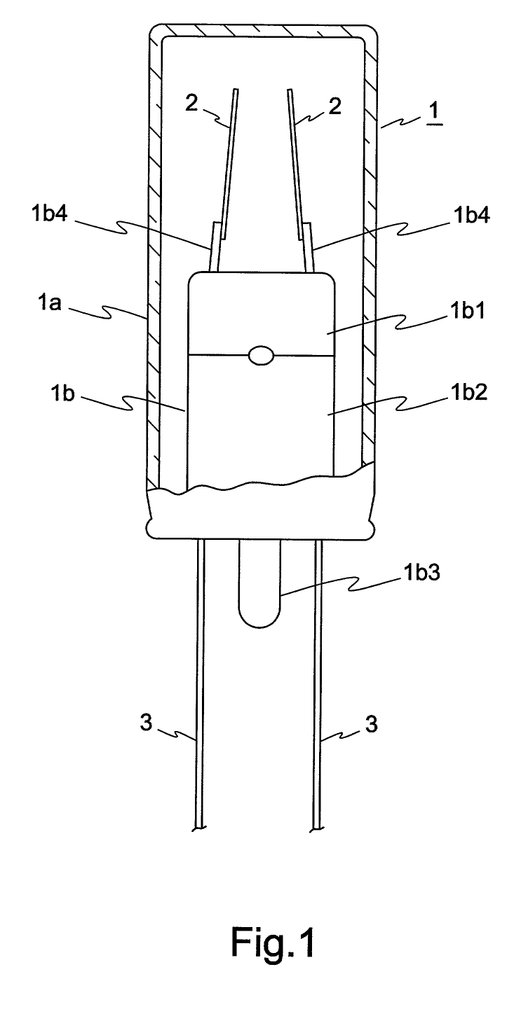

A first embodiment of the present invention will be described in detail with reference to FIG. 1.

FIG. 1 shows an enlarged side view, partly in section, of a glow starter according to a first embodiment. The glow starter is provided with a discharge vessel 1, a pair of electrodes 2 in the discharge vessel 1, and a pair of outer conductive wires 3.

The discharge vessel 1 comprises a tube 1a, and stem 1b. The tube 1a made of a soft glass, is filled with a rare gas and mercury (Hg), and can substantially transmit ultraviolet rays of about 300 nm or less generated by a rare gas discharge and a mercury vapor discharge. The soft glass, which mainly comprises silicon oxide (SiO₂), but includes no more than about 0.01 weight % of iron oxide (Fe₂O₃), has a coefficient of thermal expansion of about 40*10⁻⁷/° C. or more at a temperature between about 100 and about 300° C. The discharge vessel may transmit about 20% or more of ultraviolet rays of about 254 nm generated by a mercury vapor discharge.

The stem 1b, made of soft glass, is provided with a pinch sealed portion 1b1, a flare portion 1b2, and an exhaust tube 1b3. The exhaust tube 1b3, held at the pinch sealed portion 1b1, can exhaust tube 1a and introduce a filling including rare gas of argon (Ar) of a pressure of about 1.2*10³Pa, and mercury (Hg) of very small amount. Each of inner conductive wires 1a4 is respectively connected to the outer conductive wires 3 via a dumet wire (not shown) embedded in the pinch sealed portion 1b1.

The transmittance of the glass may be about 20% or more. It is more preferable that the transmittance is about 40% or more. The discharge vessel 1 may be made of soft glass, quartz glass, or light-transmitting ceramics. When the discharge vessel is made of soft glass, existing machines and processes for manufacturing conventional grow starters can be easily utilized. Therefore, the glow starter can be cheaply manufactured. Furthermore, soft glass, e.g., soda-lime glass, comprises mainly sodium oxide, calcium oxide, and silicon oxide (Na₂O—CaO—5SiO₂). The soda-lime glass may further comprise aluminum oxide (Al₂O₃), magnesium oxide (MgO), or potassium (K₂O), and so on. However, any impurities, e.g., iron oxide (Fe₂O₃), should be minimized. When iron oxide (Fe₂O₃) is comprised present beyond a minimal amount, it is difficult for ultraviolet rays to transmit outwardly. The amount of iron oxide (Fe₂O₃) may be about 0.01 weight % or less. When amount of iron oxide (Fe₂O₃) is about 20 ppm or less, ultraviolet rays can be transmitted more easily. Furthermore, lead oxide (PbO) should be minimized to improve the transmittance of ultraviolet rays.

One end of each of electrodes 2, made of bimetal, is connected to one end of a respective inner conductive wire 1b4. The other ends of the electrodes 2 have a predetermined space therebetween. When the electrodes 2 generate a glow discharge, the electrodes 2 themselves are heated by the glow discharge, so that the ends of the electrodes 2 can come into contact. The electrodes 2 may further have an emitter made of, e.g., barium oxide (BaO), or an activator made of, e.g., barium (Ba) , or lanthanum (La), in order to generate a glow arc more easily.

The filling including rare gas can generate ultraviolet rays having a wavelength of about 300 nm or less. The filling may further comprise mercury (Hg). The rare gas may further comprise an organic compound gas including hydrogen (H₂), or propane (C₃H₈) in order to increase the discharge current. The rare gas may comprise argon (Ar) and neon (Ne) in order to reduce the starting voltage of the glow starter. For example, the starting pulse voltage is about 1.2 KV in this embodiment.

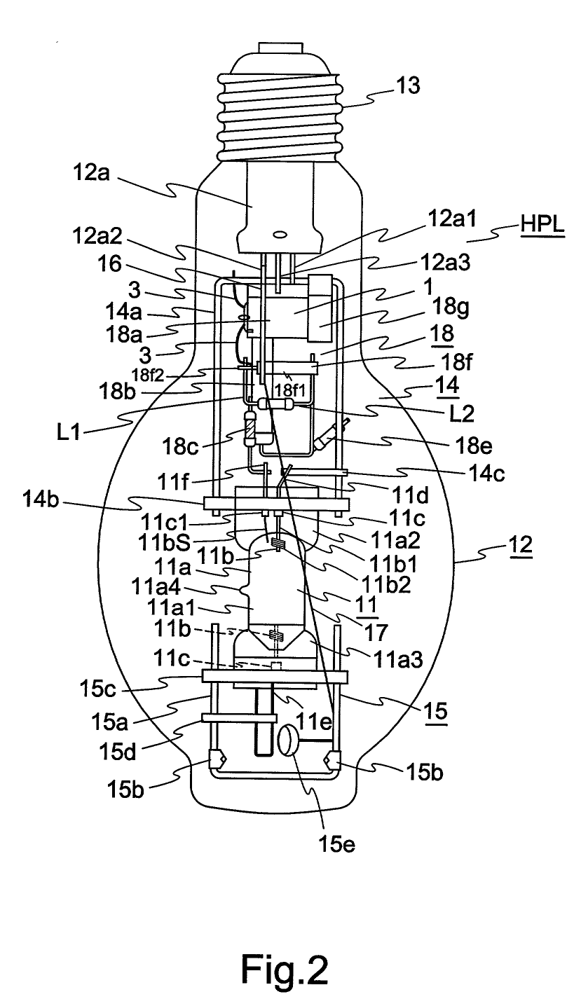

FIG. 2 is a side view of a high pressure discharge lamp. Similar reference characters designate identical or corresponding elements of the above embodiment. Therefore, detailed explanation of the structure will not be provided.

The high pressure discharge lamp HPL, e.g., a metal halide lamp having a rated power of about 400 W, comprises an arc tube 11, an outer bulb 12, a lamp cap 13, an upper supporting element 14, a lower supporting element 15, connecting conductors 16, 17 and a starting device 18.

The arc tube 11 comprises a light-transmitting discharge vessel 11a made of quartz glass, and a discharge space 11a1 filled with an ionizable gas including mercury (Hg), a rare gas, e.g., argon (Ar) of about 6.7*10³Pa at filling pressure, and a metal halide, e.g., a total amount of both scandium iodide (ScI) and sodium iodide (NaI) of about 30 mg, and sodium iodide (NaBr) of about 2,7 mg.

The metal halide may comprise either bromide (Br) or iodide (I), and either rare earth elements or alkaline metals. The rare gas may be neon (Ne), argon (Ar), or xenon (Xe). The discharge vessel 11a, having an inner diameter of about 20 mm, air-tightly closed at a pair of sealing portions 11a2, 11a3, can transmit visible light and ultraviolet rays having a wavelength of about 300 nm or less. The discharge vessel 11a further has an exhausting portion 11a4. The inner surface of the sealing portion 11a2 is formed into a hemisphere shape. However, the inner surface of the sealing portion 11a3 is formed into a cone shape. The sealing portion 11a3 may have a heat-insulating layer on the outer surface thereof. Of course, other shapes and sizes can be used. The discharge vessel 11a may be made of a ceramics having light-transmitting characteristics , e.g., either mono-crystalline or poly-crystalline alumina, yttrium alumnum garnet (YAG), or yttrium oxide (YOX). The bulb wall loading of the arc tube 11 is about 17.7 W/cm², for example.

Each of electrodes 11b, made of tungsten, comprises an electrode rod 11b1, and a coil 11b2 arranged near the tip of the rod 11b1. One end of each of the electrodes 11b is respectively embedded in the sealing portions 11a2, 11a3 and connected to one of outer conductive wires 11d, 11e via molybdenum foils 11c embedded in the sealing portions 11a2, 11a3. The outer conductive wire 11d extends outwardly from the discharge vessel 11. The outer conductive wire 11e, formed into a U-shape, extends outwardly from the sealing portion 11a3. The ends of electrodes 11b are separated by about 36 mm.

The outer bulb 12, made of hard glass, includes a main portion having a maximum outer diameter, a neck portion sealed by a flare stem 12a, and a summit portion. Of course, other shapes and sizes can be used. The flare stem 12a holds a pair of conductive wires 12a1, 12a2, and an anchor 12a3. The outer bulb 12 may be filled with an inert gas, e.g., nitrogen. Also the bulb 12 is covered with fluorine-containing polymer, so as not to be scattered if it is broken.

An aid electrode 11bS, made of tungsten, is further connected to a conductive wire 11f having a molybdenum foil 11c1 embedded in the sealing portion 11a2. A tip of the aid electrode 11bS is arranged adjacent to the electrode 11b.

The lamp cap 13 held by the neck portion includes a shell portion and a center contact, which are respectively connected to the conductive wires 12a1, 12a2.

The upper supporting element 14 comprises a U-shaped current conductor 14a, a metal band 14b, and a thin conductor 14c. The U-shaped current conductor 14a is held by the conductive wire 12a1 and the anchor 12a3 by means of welding. The metal band 14b, which is welded with the U-shaped current conductor 14a, fastens the sealing portion 11a2 of the discharge vessel 11a. The thin conductor 14c is connected to the outer conductive wire 11d at one end thereof, and welded with the U-shaped current conductor 14a at the other end thereof. Accordingly, the upper electrode 11b is connected in series to the molybdenum foil 11c, the outer conductive wire 11d, the thin conductor 14c, the U-shaped current conductor 14a, the conductive wire 12a1, and the shell portion of the lamp cap 13.

The lower supporting element 15 comprises a U-shaped current conductor 15a, a spring member 15b, a metal band 15c, a thin conductor 15d, and a getter 15e. The U-shaped current conductor 15a mechanically supports the arc tube 11. The spring member 15b, which is welded with the U-shaped current conductor 15a, is arranged so as to touch itself to the inner surface of the summit portion of the outer bulb 12. The metal band 15c, which is welded with the U-shaped current conductor 15a, fastens the sealing portion 11b3 of the discharge vessel 11a. The thin conductor 15d is connected between the U-shaped current conductor 15a and the U-shaped outer conductive wire 11e. The getter 15e, welded the U-shaped current conductor 15a, can absorb an impurity gas in the outer bulb 12.

The connecting conductor 16, which is welded with the conductive wire 12a2 at one end, is supported apart from the upper supporting element 14. The connecting conductor 17 made of a fine wire is welded with the connecting conductor 16 at one end. The other end of the connecting conductor 17 is welded with the U-shaped current conductor 15a, so that the connecting conductor 17 is arranged along the arc tube 11. Accordingly, the lower electrode 11b is connected in series to the molybdenum foil 11c, the outer conductive wire 11e, the thin conductor 15d, the U-shaped current conductor 15a, the connecting conductors 17, 16, the conductive wire 12a2, and the center contact of the lamp cap 13.

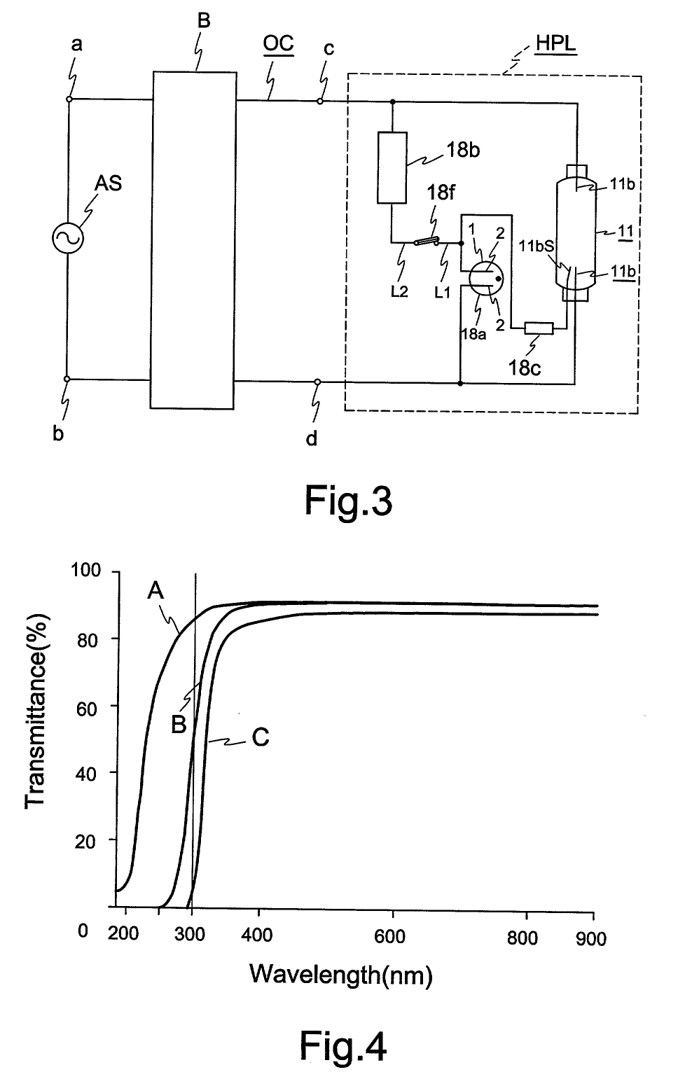

The starting device 18, to which occurs a starting pulse voltage is applied from a ballast B shown in FIG. 3 and which produces a photoelectric effect in the arc tube 11, comprises a glow starter 18a shown in FIG. 1, resistors 18b, 18c, insulators 18d, 18e, a bimetal element 18f, and a metal holder 18g supporting the glow starter 18a. The metal holder 18g supports the glow starter 18a so as not to cut off ultraviolet rays generated by the glow starter 18a. The outer conductive wire 3 of the glow starter 18a is connected to the U-shaped current conductor 14a. The other conductive wire 3 is connected to the lead wire L1 of the insulator 18d. One lead wire of the resistor 18b is connected to the connecting conductor 16. The other lead wire of the resistor 18b is connected to the lead wire L2 of the insulator 18d. Moreover, one lead wire of the resistor 18c is connected to the lead wire L1 of the insulator 18d. The other lead wire of the resistor 18c is connected to the aid electrode 11bS via a molybdenum foil 11f. The insulator 18e is arranged between the resistor 18b and the U-shaped current conductor 14a. The bimetal element 18f, which comprises a bimetal plate 18f1 and a contacting member 18f2, is usually closed. The one end of the bimetal plate 18f1 is connected to the lead wire L2 of the insulator 18d by welding. The one end of the contacting member 18f2 is welded with the other end of the bimetal plate 18f1. Therefore, the other end of the contacting member 18f2 can separate from the lead wire L1, when the bimetal plate 18f1 deforms. Furthermore, the glow starter 18a is arranged to irradiate the arc tube 11 with ultraviolet rays generated therefrom. In this embodiment, the glow starter 18a is separated from the arc tube 11 by about 10 cm. Furthermore, the glow starter 18a may be held by a case, which transmits the ultraviolet rays generated by the glow starter 18a.

FIG. 3 shows a circuit diagram of the high pressure discharge lamp apparatus. The series circuit, which includes the resistor 18b, the lead wire L2 of the insulator 18d, the bimetal element 18f, the lead wire L1 of the insulator 18d, and the glow starter 18a, is connected in parallel to the arc tube 11. Moreover, another series circuit, including the resistor 18b, the lead wire L2, the bimetal element 18f, the lead wire L1, and the resistor 18c, is connected between the upper electrode 11b and the aid electrode 11bS. An operating circuit OC comprises an alternating current power supply AS having a rated voltage of about 200V, a ballast B having terminals a, b, c, and d, and the high pressure discharge lamp HPL. The ballast B for a mercury vapor lamp outputs about 400 W. The ballast B, having a rated voltage of about 200V, mainly comprises an inductor, and can stably light up the metal halide lamp. The ballast may have a rated input voltage of about 100V, and supplies a secondary voltage between about 200V and about 220V to the high pressure discharge lamp. Of course, the ballast may be specifically designed for a metal halide lamp.

When the ballast for a mercury vapor lamp is used for a metal halide lamp, it has been a concern that the lamp may occasionally extinguish during lamp operation. However, when the high pressure discharge lamp has a filling containing mainly scandium iodide (ScI) and sodium iodide (NaI), the metal halide lamp can remain lit.

When the alternating current power AS is supplied to the ballast B, the ballast generates a secondary voltage applied to the high pressure discharge lamp HPL. However, the high pressure discharge lamp HPL can not start yet. The glow starter 18a generates a glow discharge between the electrodes 2, when the secondary voltage is supplied to the high pressure discharge lamp HPL. The glow discharge generates ultraviolet rays of about 300 nm or less which irradiate the arc tube 11 through the discharge vessel 1. As a result, the photoelectric effect occurs in the arc tube 11, and secondary electrons from the electrodes 1b are easily generated. Furthermore, the electrodes 2 of the glow starter 18a are heated by the glow discharge thereof, so that the electrodes 2 deform and touch each other. After the electrodes 2 touch, the glow starter 18a operates as a resistor in order to draw an appropriate current from the ballast B. For a while, the electrodes 2 cool because they are not generating a glow discharge. Therefore, the electrodes 2 separate from one another. At that time, a starting pulse voltage, which is generated by a counter-electromotive force within the ballast B, is supplied between the lower electrode 1b and the aid electrode 1bS, so that an aid discharge occurs. The aid discharge aids a main discharge between the electrodes 1b, 1b. As a result, the high pressure discharge lamp HPL starts to light up.

After a while, the main discharge also heats the bimetal element 18f, so that the contacting member 18f2 parts from the lead wire L1 of the insulator 18d. Therefore, the glow starter 18a cannot operate again because it is disconnected from the high pressure discharge lamp HPL. The aid electrode 11bS also is disconnected electrically and does not discharge during lamp operation.

FIG. 4 shows a graph of transmittance as a function of wavelength according to the first embodiment. The vertical axis of the graph shown in FIG. 4 indicates transmittance (%), and the horizontal axis indicates wavelength (nm). The lines A, B, and C respectively indicate the transmittance of a first glass, a second glass, and a comparative glass. Each glass has a thickness of about 0.8 mm.

The first glass, which is made of soda-lime glass including iron oxide (Fe₂O₃) of about 0.01 weight % or less, transmits about 68% of the ultraviolet rays at a wavelength of about 254 nm, and about 88% of the ultraviolet rays at a wavelength of about 300 nm. The detailed composition of the first glass is as follows: silicon oxide (SiO₂) of about 68.90 weight %, aluminum oxide (Al₂O₃) of about 1.32 weight %, iron oxide (Fe₂O₃) of about 17 ppm (0.0017 weight %), sodium oxide (Na₂O) of about 8.53 weight %, potassium oxide (K₂O) of about 8.56 weight %, calcium oxide (CaO) of about 78 ppm (0.0078 weight %), barium oxide (BaO) of about 9.97 weight %, boron oxide (B₂O₃) about 2.33 weight %, titanium oxide (TiO₂) of about 5 ppm (0.0005 weight %), and chlorine (Cl) of about 0.27 weight %. Furthermore, the first glass has a coefficient of thermal expansion of about 96.9*10⁻⁷/° C., a glass transition temperature of about 500° C., a contraction temperature of about 570° C., a softening temperature of about 679° C., an annealing point of about 487° C., and a strain temperature of about 443° C.

The second glass, which is made of soft glass which is lead glass with the lead (Pb) substantially removed, transmits about 48% at a wavelength of about 300 nm.

The comparative glass, which is made of lead glass used for a flare stem, transmits about 4% at a wavelength of about 300 nm. The detailed composition of the comparative glass is follows: silicon oxide (SiO₂) of about 70.30 weight %, aluminum oxide (Al₂O₃) of about 1.91 weight %, iron oxide (Fe₂O₃) of about 0.036 weight %, sodium oxide (Na₂O) of about 16.00 weight %, potassium oxide (K₂O) of about 1.24 weight %, calcium oxide (CaO) of about 5.12 weight %, magnesium oxide (MgO) of about 3.34 weight %, strontium oxide (SrO) of about 0.02 weight %, barium oxide (BaO) of about 0.09 weight %, boron oxide (B₂O₃) of about 0.83 weight %, titanium oxide (TiO₂) of about 0.01 weight %, zinc oxide (ZnO) of about 0.08 weight %, zirconium oxide (ZrO₂) of about 0.03 weight %, phosphorus oxide (P₂O₅) of about 0.32 weight %, antimony oxide (Sb₂O₃) of about 0.23 weight %, sulfur oxide (SO₃) of about 0.16 weight %, and chlorine (Cl) of about 0.02 weight %. Furthermore, the comparative glass has a coefficient of thermal expansion of about 95.6*10⁻⁷/° C., a glass transition temperature of about 540° C., a contraction temperature of about 600° C., a softening temperature of about 693° C., an annealing point of about 517° C., and a strain temperature of about 473° C.

Twenty of each of three metal halide lamps, which utilize glow starters and have the first, the second, or the comparative glass, were manufactured. The metal halide lamps, using the glow starter and made of the first or the second glass, could start to light up rapidly in at least in ten seconds. However, the metal halide lamps, using the glow starter and made of the comparative glass, could not start in two minutes. When the glass of the glow starter transmits about 20% or more at the wavelength of about 300 nm or less, the metal halide lamp can start easily. Moreover, when the glass of the glow starter transmits about 40% or more, the arc tube can sufficiently receive ultraviolet rays. Accordingly, the glow starter can be arranged apart from the arc tube, so as not to obstruct the visible light generated from the arc tube.

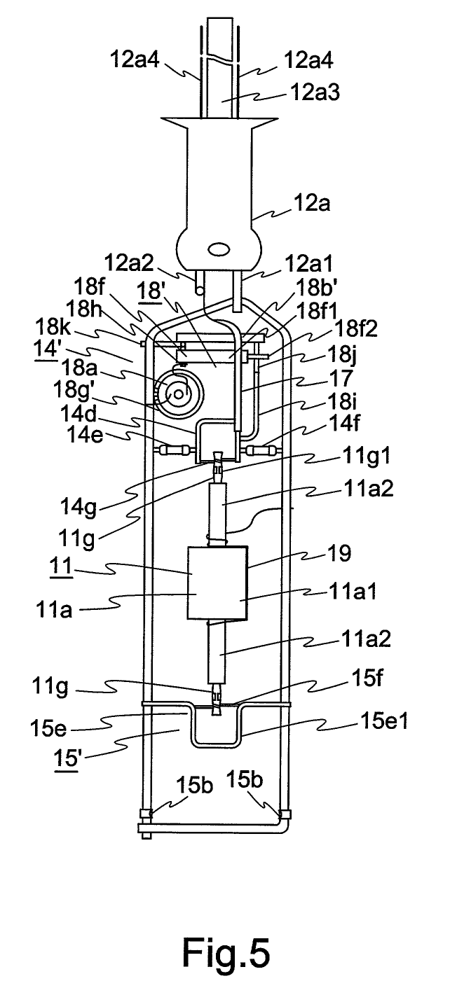

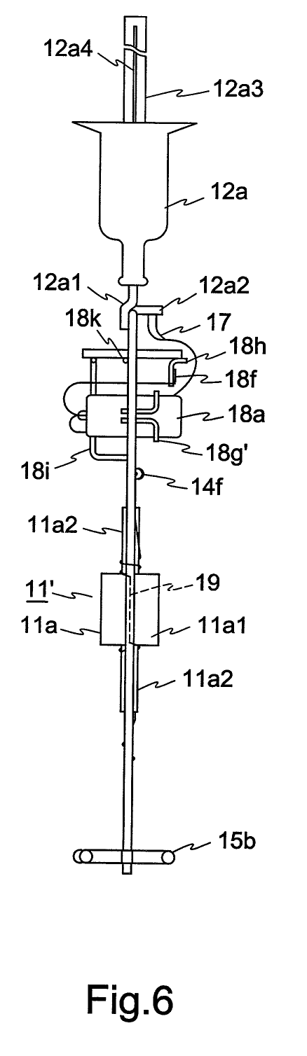

FIG. 5 shows a side view of an assembly of a metal halide lamp according to a second embodiment. An outer bulb and a lamp cap are not shown in FIG. 5. FIG. 6 shows another side view of the assembly of the metal halide lamp shown in FIG. 5. The same reference characters designate identical or corresponding elements as those of the first embodiment. Therefore, a detailed explanation of such structure will not be provided. In this embodiment, a glow starter 18a is the same as that of the first embodiment, and an arc tube 11 is made of light-transmitting ceramics.

The assembly is provided with an arc tube 11, a flare stem 12a, an upper supporting element 14′, a lower supporting element 15′, connecting conductors 17, a starting device 18, and a starting aid conductor 19.

The arc tube 11 comprises a discharge vessel 11a made of a light-transmitting ceramics, which has a discharge space portion 11a1 and sealing portions 11a2 formed at opposite ends of the discharge space portion 11a1. Each of the sealing portions 11a2 has a slit introduced a conductor 11g. The conductor 11g made of niobium (Nb) is also sealed in the slit by a sealing compound for the ceramics. A pair of electrodes (not shown), each respectively connected to one of the conductors 11g, is arranged in the discharge vessel 11a. The sealing compound seals the discharge vessel 11a at sealing portions 11a2, and also fixes the electrodes in the discharge space. The discharge vessel 11a is filled with a filling including mercury (Hg), a rare gas, e.g., argon (Ar) , and a metal halide, e.g., sodium iodide (NaI), dysprosium iodide (DyI), and cesium iodide (CsI).

The flare stem 12a comprises a pair of inner conductive wires 12a1, 12a2, an exhaust tube 12a3, and a pair of outer conductive wires 12a4.

The upper supporting element 14′ comprises a rectangular conductor 14a′, a U-shaped conductor 14d, insulators 14e, 14f, and a lead wire 14g. The rectangular conductor 14a′ is welded to the inner conductive wire 12a1, and is connected electrically thereto. The arc tube 11 is arranged between the legs of the rectangular conductor 14a′. One end of each of the insulators 14e, 14f is fixed to the rectangular conductor 14a′, and the other end of each of the insulators 14e, 14f supports the U-shaped conductor 14d. The lead wire 14g, which is welded to the U-shaped conductor 14d, is also welded to the upper side of the arc tube 11.

The lower supporting element 15′ comprises the rectangular conductor 14a′, a pair of spring members 15b, a holding conductor 15e, and a lead wire 15f. The holding conductor 15e is welded to the rectangular conductor 14a′ at each of its ends. The spring members 15b, which are welded to the rectangular conductor 14a′, are arranged so as to touch the inner surface of the summit portion of an outer bulb (not shown). The lead wire 15f, which is welded to the U-shaped portion 15e1 of the holding conductor 15e, holds the lower side of the arc tube 11.

The connecting conductor 17 made of a ribbon-shaped wire is welded to the inner conductive wire 12a2 at one end. The other end of the connecting conductor 17 is welded to the U-shaped current conductor 14d.

The starting device 18′ comprises a glow starter 18a, a ceramics resistor 18b′, a metal holder 18g′ supporting the glow starter 18a, connecting conductors 18h, 18i, and 18j, a contacting member 18k, and a bimetal element 18f. One outer conductive wire 3 of the glow starter 18a is connected to the connecting conductor 18h. The other outer conductive wire 3 of the glow starter 18a is welded to the rectangular conductor 14a′. The ceramics resistor 18b′, embedded in a ceramics substrate, is connected to the connecting conductors 18i, 18j. The connecting conductor 18i is welded to the U-shaped current conductor 14d. The one end of the contacting member 18k is connected to the ceramics substrate, and the other end thereof is welded to the rectangular conductor 14a′. Therefore, both the ceramics substrate and the bimetal element 18fis held by the contacting member 18k and the connecting conductor 18i. The bimetal element 18f comprises a bimetal plate 18f1, and a contacting member 18f2.

The starting aid conductor 19 made of a fine conductive wire, is welded to the rectangular conductor 14a′ at one end. The fine conductive wire 19 also is wound around the one sealing portion 11a2 twice, and arranged along the surface of the discharge portion 11a1. The other end of the fine conductive wire 19 is wound around the other sealing portion 11a2.

Moreover, the metal halide lamp has a rated lamp power of about 360 W, a luminous efficiency of about 901 m/W, a color temperature of about 4000K, and a general color rendering index of about 85.

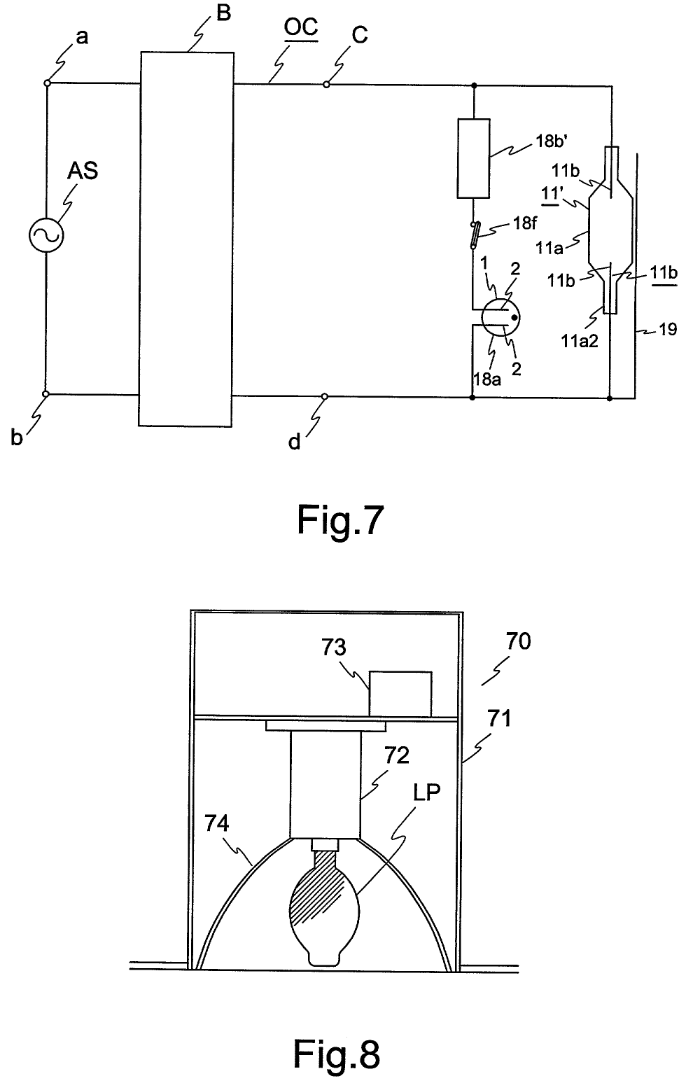

FIG. 7 shows a circuit diagram of a high pressure discharge lamp apparatus according to the second embodiment. The same reference characters designate identical or corresponding elements to the circuit diagram of the first embodiment shown in FIG. 3. Therefore, a detail explanation of such structure will not be provided. A series circuit, which includes the ceramics resistor 18b′, the bimetal element 18f, and the glow starter 18a, is connected in parallel to the arc tube 11.

When the alternating current power AS is supplied to-a ballast B, which can be that used with mercury vapor lamps, the ballast generates a secondary voltage which is applied to the high pressure discharge lamp HPL. However, the high pressure discharge lamp HPL can not start yet. The glow starter 18a generates a glow discharge between the electrodes 2, when the secondary voltage is supplied to the high pressure discharge lamp HPL. The glow discharge generates ultraviolet rays of about 300 nm or less, e.g., 296 nm, so that the ultraviolet rays can irradiate the arc tube 11 through the discharge vessel 1. Furthermore, argon (Ar) also generates ultraviolet rays by means of resonance radiation. As a result, the photoelectric effect occurs in the arc tube 11, and secondary electrons are easily generated from the electrodes 1b. Furthermore, the electrodes 2 of the glow starter 18a are heated by the glow discharge thereof, so that the electrodes 2 deform and touch each other. After the electrodes 2 touch, the glow starter 18a operates as a resistor in order to drawn an appropriate current from the ballast B. For a while, the electrodes 2 cool because they are not generating a glow discharge. Therefore, the electrodes 2 separate from each other. Then, a starting pulse voltage, which is generated by a counter-electromotive force in the ballast B, is supplied between the upper electrode 1b and the starting aid conductor 19, so that an arc discharge starts between the upper electrode 1b and the starting aid conductor 19. The aid discharge aids a main discharge between the electrodes 1b. As a result, the high pressure discharge lamp HPL starts to light up. After a while, the main discharge also heats the bimetal element 18f, so that the contacting member 18f2 parts from the connecting conductor 18j. Therefore, the glow starter 18a cannot operate again because it is disconnected from the high pressure discharge lamp HPL.

Also in this embodiment, 20 of each of three metal halide lamps, which utilize glow starters and have the first, the second, or the comparative glass, were manufactured. The results of a starting test were the same as in the first embodiment. That is, the metal halide lamps, using the glow starter made of the first or the second glass, can start to light up rapidly at least in ten seconds. However, the metal halide lamps, using the glow starter and made of the comparative glass, cannot start in two minutes.

2. FIG. 8 shows a side view, partly in section, of a lighting fixture. The lighting fixture 70 is provided with a body 71 having a lamp socket 72, a metal halide lamp LP of the first or second embodiment. A reflector 74 and ballast 73 are also provided in the body 71.

According to one aspect of the invention, a glow starter comprises a discharge vessel, filled with a gas mix including a rare gas. The glow starter transmits ultraviolet rays substantially of about 300 nm or less. A pair of electrodes, which are arranged in the discharge vessel, are adapted and arranged to touch each other as a result of being heated by a glow discharge.

What is claimed is:

1. A glow starter, comprising:
a discharge vessel, filled with a filling including a rare gas, substantially transmitting ultraviolet rays of about 300 nm or less; and
a pair of electrodes, which are arranged in the discharge vessel, being adapted and arranged to touch each other by being heated by a glow discharge.

2. A glow starter according to claim 1, wherein the rare gas is made of mainly argon (Ar) and generates ultraviolet rays of wavelength of about 300 nm or less.

3. A glow starter according to claim 1 or 2, wherein the discharge vessel transmits about 20% or more of ultraviolet rays of wavelength of about 300 nm.

4. A glow starter according to claim 1, wherein the discharge vessel is made of a soft glass and transmits about 20% or more of ultraviolet rays of wavelength of about 254 nm, and the filling further includes mercury (Hg).

5. A glow starter according to claim 4, wherein the soft glass of the discharge vessel comprises mainly silicone oxide (SiO₂) and about 0.01 weight % or less of iron oxide (Fe₂O₃).

6. A high pressure discharge lamp comprising:
an arc tube;
a glow starter, which irradiates the arc tube with ultraviolet rays, comprising:
a discharge vessel, filled with a filling including a rare gas, substantially transmitting ultraviolet rays of about 300 nm or less; and
a pair of electrodes, which are arranged in the discharge vessel, being adapted and arranged to touch each other by being heated by a glow discharge; and
an outer bulb accommodating the arc tube and the glow starter.

7. A high pressure discharge lamp apparatus comprising:
a high pressure discharge lamp comprising:
an arc tube;
a glow starter, which irradiates ultraviolet rays to the arc tube, comprising:
a discharge vessel, filled with a filling including a rare gas, substantially transmitting ultraviolet rays of about 300 nm or less; and
a pair of electrodes, which are arranged in the discharge vessel, being adapted and arranged to touch each other by being heated by a glow discharge;
an outer bulb accommodating the arc tube, and the glow starter; and
a ballast, which has a rated voltage of about 100V, and supplies a secondary voltage between about 200V and about 220V to the high pressure discharge lamp, or has a rated voltage of about 200V, arranged in series with the high pressure discharge lamp.

8. A lighting fixture comprising:
a high pressure discharge lamp apparatus comprising:
a high pressure discharge lamp comprising:
an arc tube;
a glow starter, which irradiates ultraviolet rays to the arc tube, comprising:
a discharge vessel, filled with a filling including a rare gas, substantially transmitting ultraviolet rays of about 300 nm or less; and
a pair of electrodes, which are arranged in the discharge vessel, being adapted and arranged to touch each other by being heated by a glow discharge;
an outer bulb accommodating the arc tube, and the glow starter; and
a ballast, which has a rated voltage of about 100V, and supplies a secondary voltage between about 200V and about 220V to the high pressure discharge lamp, or has a rated voltage of about 200V, arranged in series with the high pressure discharge lamp; and
a body having a lamp socket and a reflector.
